(19) United States
(12) Patent Application Publication
(10) Pub. No.: US 2012/0324716 A1
(43) Pub. Date: Dec. 27, 2012

(54) METHOD FOR WRAPPING INSULATING TAPE ON ELECTRODYNAMIC MACHINE INSULATED COILS

(75) Inventor: James Shover, Muson, OH (US)

(73) Assignee: SIEMENS INDUSTRY, INC., Alpharetta, GA (US)

(21) Appl. No.: 13/164,834

(22) Filed: Jun. 21, 2011

(51) Int. Cl. H02K 15/00

(52) U.S. Cl. 29/596

(57) ABSTRACT

Electrodynamic machine conductive coils, such as those found in AC induction motors are wrapped with insulating tape layers. A tape pair having pre-set laterally overlapping (I) coupled first and second tape ribbons is wrapped about at least a portion of an electrodynamic machine conductive coil. The tape pair may be obtained in pre-configured form from a tape vendor or may be configured on site with a tape pair forming apparatus. Coils insulated with the present invention can be wrapped with more precise uniform tape offset between layers. Multiple layers are also applied simultaneously in a single wrap sequence, with less effort and time than by known single layer tape wrapping methods.

### BACKGROUND OF THE DISCLOSURE

1. Field of the Invention

The invention relates to methods for electrically insulating coils for electrodynamic machines, and in particular stator coils suitable for alternating current (AC) induction motors. Coils insulated by the present invention provide for winding of insulating tape in an overlapping helical pattern about the coil circumference, and in particular about its compound curved end portions and leads. Wrapping overlap is often in the range of 10% to 40% of tape width, with 25% being a relatively commonly applied overlap percentage. Application of the present invention method better assures consistent desired overlap between adjoin wrapping turns and reduces the quantity of wrapping turns needed for application of multiple insulating tape layers.

2. Description of the Prior Art

Electrodynamic machines generate electromagnetic forces (EMF) between a rotor and stator that are in relative motion. The general physical principles, construction and operation of AC motors are known to those skilled in the art. Known AC motors have a rotating rotor and shaft. Torque generated on the rotating shaft enables the motor to perform useful work. A rotating magnetic field induced within poles formed within a stator ring generates electromagnetic force (EMF) that rotates the rotor and its attached shaft.

The AC induction motor stator ring has a stack of annularly shaped stator lamina that form radial slots extending generally axially from one end of the rotor to the other. The stator lamina radial slots receive stator coils that are arrayed in poles about the circumference of the stator ring. Application of current sequentially to the stator poles induces rotating magnetic fields in the stator ring. The induced EMF in turn causes rotor and shaft rotation.

An exemplary known stator coil 20 is shown in FIGS. 1-3. The stator coil 20 is a wound continuous conductive wire bundle that is formed into a three dimensional shape. The coil 20 has a pair of generally parallel straight sections 22 and 24 having respective generally rectangular cross sections that are oriented for insertion into the stator ring radial slots. In order to accomplish the desired radial orientation of the straight sections 22, 24 within the radial slots, the coil 20 is formed with end portions 26, 28, often having a compound curve U-bends 26A and 28A. Leads 30 provided on the coil end portion 26 are coupled to an electric current power source. When current is applied to the leads 30, an electromagnetic field is induced within the coil. As is known by those skilled in the art, the continuous ribbon wire 32 forming the coil 20 has an insulating outer layer coating in order to optimize the magnetic field strength induced within the coil. The wire 32 is typically constructed of copper and coated with a resin or other electrically insulative layer that is thin relative to the wire dimensions.

As is well known in the art, individual stator coils 20 are electrically isolated from their surrounding environment by a circumferential insulation layer, often a multi-layered combination of adhesive backed tape and hardened resin. The insulating layer is applied using known techniques. In FIGS. 2 and 3, the insulation layer 34 is depicted schematically as one or more spiral wrapped circumferential layers of adhesive backed tape 36 that have overlapping or indexed lateral edges in adjoining wrapped segments, depicted as I in FIG. 2. The tape layers 36 may comprise a plurality of different types of tape wrappings, e.g., polymer and/or metallic glass, or homogeneous material for all layers. The taped layer 36 is thereafter coated with a multi-part epoxy resin 33. Often stator coils are supplied to motor manufacturers with only the spiral wrapped tape layer 36, ready for application of the resin 38 by the motor manufacturer. Application of a resin coating over a wrapped coil is not part of the present invention, and is not specifically claimed herein.

The stator coil insulation layer 34 is often applied after final forming of the coil wire bundle to its final intended shape. The earliest forms of tape insulation application were performed totally by hand. Later, cost savings were achieved by utilizing machine wound tape layers on the straight sections 22, 24. However, the compound curved end portions 26, 28 and the coil leads 30 still needed to be tape-wrapped by hand labor. Hand taping is expensive, time consuming, and may be prone human error by failure to apply tape in a uniform helical winding pattern with a designated overlap I in adjoining wrapped segments. Generally it has not been found practical to machine wind the compound curved end portions 26, 28, including the U-bends 26A, 28A, or the leads 30 after the coil is formed to its final intended configuration.

Thus, a need exists in the art for a method for taping electrodynamic machine coils that reduces insulated taping operations needed to complete a coil wrapping, particularly on the coil end portions and leads that historically have required tape hand wrapping. While it may not be feasible in all manufacturing operations to replace all hand taping with machine taping processes (for example, localized taping around stator coil leads 30), reduction of taping operations reduces costs and likelihood of taping errors in the eliminated extra steps.

Another need exists in the art for a stator coil insulating tape wrapping method that better assures consistent desired indexing/overlap (“I”) between adjoining wrapped segments.

Yet another need exists in the art for a stator coil insulating tape wrapping method that more quickly and efficiently applies multiple insulating tape layers simultaneously in a uniform, repeatable pattern.

### SUMMARY OF THE INVENTION

Accordingly, an object of the invention is to reduce taping operations during electrodynamic machine coil manufacture.

Another object of the invention to apply insulating tape about a stator coil in a manner that better assures consistent desired overlap/indexing between adjoining wrapped segments.

Yet another object of the invention is to create a stator coil insulating tape wrapping method that more quickly and efficiently applies multiple insulating tape layers simultaneously in a uniform, repeatable pattern.

These and other objects are achieved in accordance with the present invention methods for wrapping induction machine stator coils, and more particularly for wrapping compound curved end portions of stator coils and their conductive leads. In accordance with the present methods, a tape pair of overlapping coupled tape ribbons is simultaneously wrapped about at least a portion of such stator coils with a desired lateral overlap/index between adjoining wrapped segments.

The present invention features a method for insulating an electrodynamic machine conductive coil, for example an AC induction motor stator coil, by providing a tape pair having laterally' overlapping coupled, such as by adhesion, first and second tape ribbons; and wrapping the tape pair about at least a portion of an electrodynamic machine conductive coil. The tape pair may be constructed by the entity that is performing the wrapping step or procured from a third party such as a tape vendor.

The present invention also features a method for insulating an electrodynamic machine conductive coil, by forming a tape pair having laterally overlapping coupled first and second tape ribbons; and wrapping the tape pair about at least a portion of an electrodynamic machine conductive coil.

The present invention additionally features a method for insulating an electrodynamic machine conductive coil. The method comprises providing a tape joining apparatus that has a rotatively mounted first tape roll of adhesive backed first tape ribbon; a rotatively mounted second tape roil of adhesive backed second tape ribbon; and a rotatively mounted third tape roll downstream the first and second rolls. The first and second tape ribbons are transported along a tape transport path to the third tape roll. Respective adjacent edges of the first and second tape ribbons are laterally overlapped in the tape transport path, so as to form an adhesively coupled tape pair that is taken up the apparatus third tape roll. Tape pair taken from the third tape roll is used to insulate at least a portion of an electrodynamic machine conductive coil by wrapping the tape pair about the coil portion.

By employing the tape wrapping methods of the present invention, the insulating tape layer can achieve more consistent offset and indexing between adjoining wrapped segments, because the pair of joined tape ribbons already has established index overlap when the pair are commonly spooled. The overlapping pair of joined tape ribbons are wider than a single tape width, and thus require fewer wrapping turns to cover a given length of coil surface. Reduction in the number of tape turns needed to cover a given length of coil simplifies the wrapping process and reduces application time. An overlapping pair of joined tape ribbons may include the same type tape material or a pair of different tape materials.

In some wrapping applications it may be possible to join more than two laterally offset tape ribbons: such as a ribbon having two three or four laterally offset ribbons. A multi-layer tape structure may be formed on a coil by selected combinations of overlapping pairs of tape ribbons applied in accordance with the teachings of the present invention and single wrapped tape layers of the same or different combinations of tape material. For example, three tape layers may be applied by application of a joined laterally offset pair of tape ribbons and a single wrap tape layer. Similarly, four tape layers may be applied by application of two sequential wrappings of joined laterally offset tape ribbon pairs applied in accordance with the teachings of the present invention. In this way the coil is provided with the tape insulation layer necessary for proper electrodynamic machine function.

The objects and features of the present invention may be applied jointly or severally in any combination or sub-combination by those skilled in the art.

### BRIEF DESCRIPTION OF THE DRAWINGS

The teachings of the present invention can be readily understood by considering the following detailed description in conjunction with the accompanying drawings, in which:

FIG. 1 is a perspective view of a known AC motor stator coil, including a coil lead;

FIG. 2 is a detailed perspective view of a coil lead of FIG. 1;

FIG. 3 is a sectional elevational view of the stator coil of FIG. 1, taken along 3-3 thereof;

FIGS. 4 and 5 are respectively schematic plan and elevational views of an exemplary tape joining apparatus used to loin a pair of tape ribbons in laterally offset (indexed) relative position, for subsequent wrapping about a stator coil of FIGS. 1-3;

FIG. 6 is an elevational cross section of the joined pair of tape ribbons of the present invention;

FIG. 7 is a schematic perspective view of a joined pair of tape ribbons of the present invention being wrapped about an exemplary coil lead;

FIG. 8 is an schematic elevational cross section of an exemplary coil lead wrapped with tape in accordance with the methods of the present invention; and

FIG. 8A, 8B and 8C are cross sections of tape layers applied in accordance with the method of the present invention: respectively two layers in FIG. 8A; three layers in FIG. 8B and four layers in FIG. 8C.

To facilitate understanding, identical reference numerals have been used, where possible, to designate identical elements that are common to the figures.

### DETAILED DESCRIPTION

After considering the following description, those skilled in the art will clearly realize that the teachings of the present invention can be readily utilized in methods for taping electrodynamic machine insulated coils, such as for example those utilized as stator coils in alternating current induction motors. As one skilled in the art can appreciate, the coil taping methods of the present invention can also be utilized in other types of electrodynamic machines, including direct current motors and generators.

### General Overview of Coil Taping

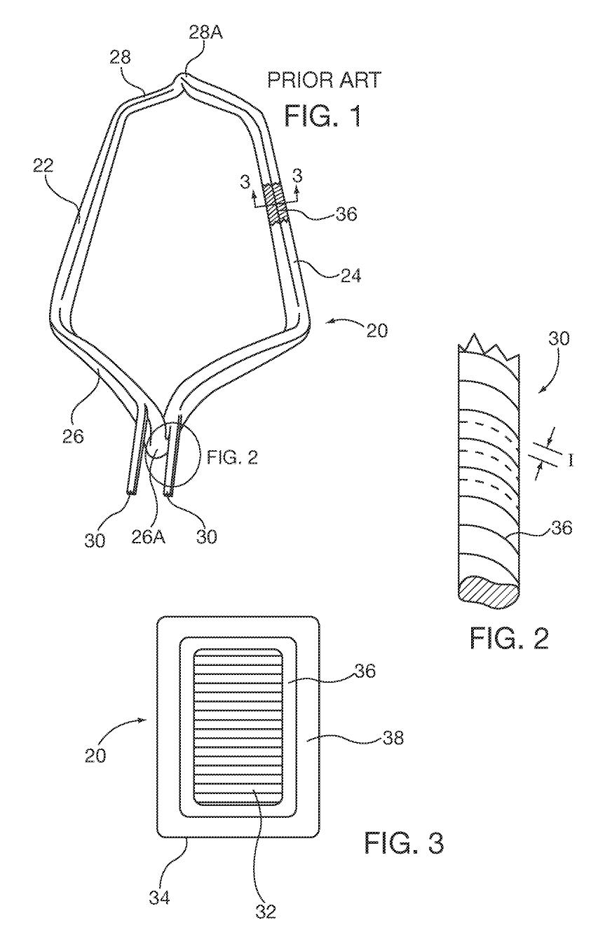

It is noted at the outset that the present invention is directed to methods for wrapping electrodynamic machine coils and not to their general structure. One skilled in the art may employ the taping methods of the present invention to any desired coil configuration. Application of the present invention is further described with reference to taping of stator coils for alternating current (AC) induction motors shown in FIGS. 1-3 herein. A stator coil 20 is formed by known manufacturing methods and is then prepared for insulation with wrapped tape. At the discretion of the manufacturer any portion of the tape wrapping operations may be performed by hand or machine or a combination, of both, depending upon the wrapping equipment available at the manufacturing facility. Generally at least the coil 20 straight portions 22, 24 are wrapped by machine.

Upon completion of insulating the straight sections 22, 24, the remaining exposed sections of the stator coil 20 are insulated by hand. Such remaining sections may, for example, include the stator coil end. portions 26, 28 with the U bends 26A, 28A, and the leads 30. Additional layers of external tape (not shown) may be added to any portion of the stator coil 20.

### DESCRIPTION OF THE PRESENT INVENTION

In application of the present. invention method, known single layer taping 36 is replaced by or supplemented by a tape pair 50 having laterally overlapping coupled first and second tape ribbons 52, 54, as shown in FIG. 6. The tape ribbons 52, 54 are preferably adhesively coupled, such as by application of respective adhesive backing surfaces 53, 55. Lateral overlap is shown as I in FIG. 6, and is selectively adjusted to meet the taping specifications set by the electrodynamic machine manufacturer. A typical overlap range is between 10 and 40 percent, with 25 percent overlap being relatively common in the industry. Tape pair 50 lateral overlap I and width may be adjusted by selecting single tape ribbons 52, 54 of widths that when coupled with a desired overlap I have an overall desired combined width. Alternatively, two single tape ribbons 52, 54 may be joined to form a tape pair 50 and their outer marginal edges trimmed to width dimensions so that the composite pair has a desired overall width and overlap.

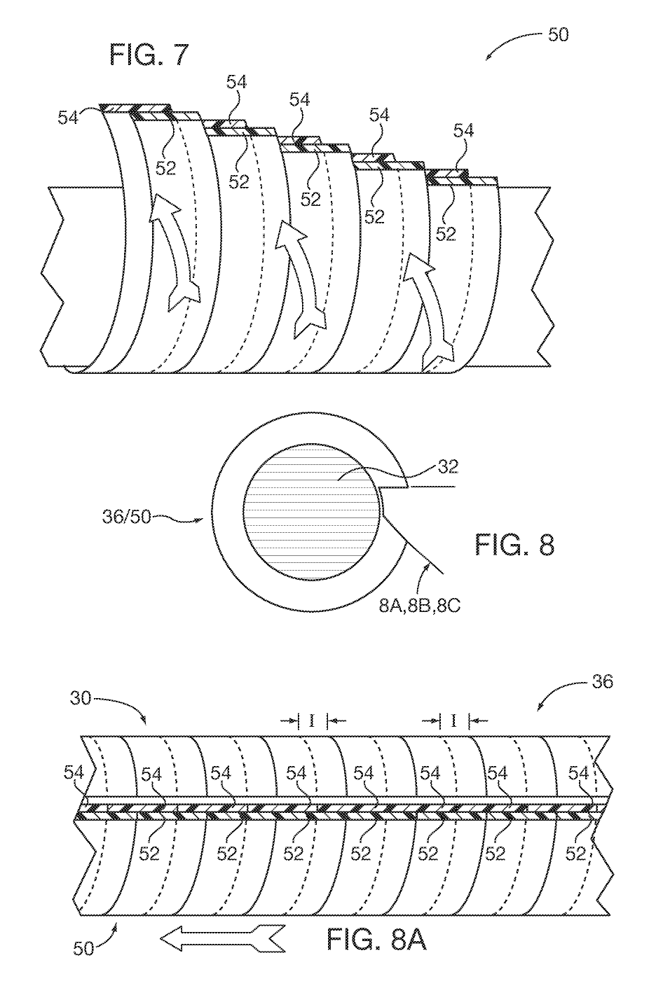

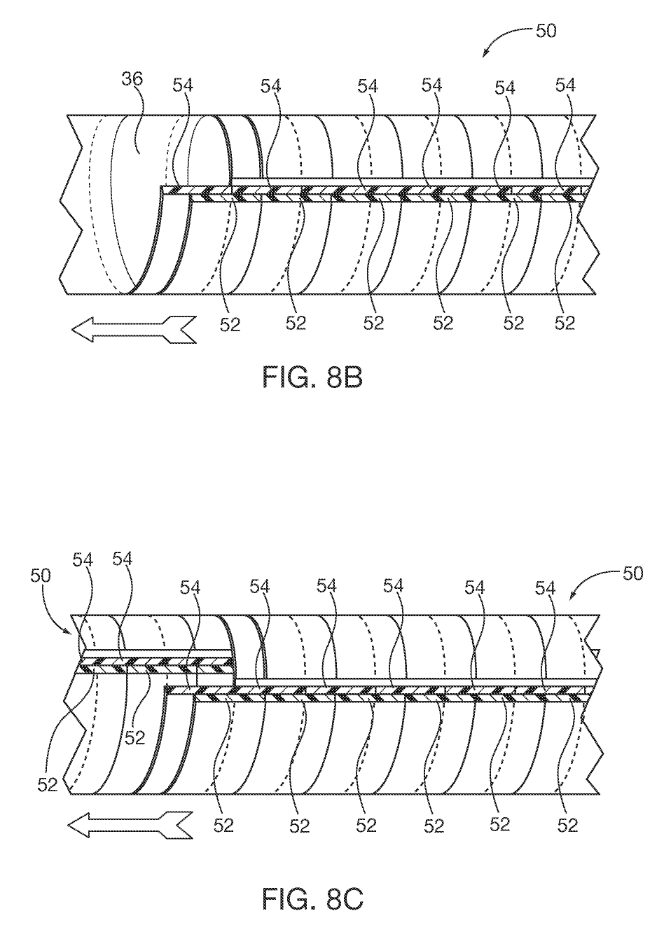

Typical tape ribbons 52, 52 are constructed of materials that are well known in the electrodynamic machine coil insulation industry. Such materials include for example mica or mica paper bonded onto a carrier with a binder epoxy and may also contain a catalyst or accelerator. The carrier may be a film or glass material and the accelerator may be for example zinc napthanate or an amine. A tape pair 50 may be constructed of two or more laterally joined tape ribbons 52, 54 and ribbons may be constructed of the same or different materials. Combinations of tape pairs 50 and single wrapped tape 36 may be sequentially wrapped about a stator coil 20 in any desired sequence to form multi-layer tape insulation, as will be described herein in reference to FIGS. 7-8C.

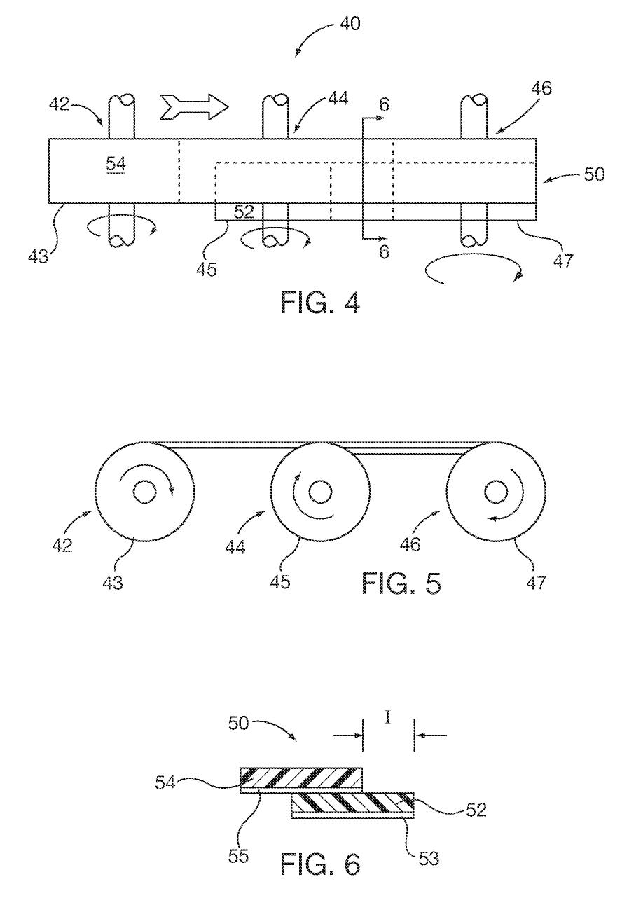

A completed tape pair 50 may be provided by a tape vendor for specific use in performing the methods of the present invention, or a manufacturer may choose to construct its own tape pairs by laterally joining separate tape rolls. An exemplary tape pair 50 fabrication apparatus 40 is shown in FIGS. 4 and 5. The apparatus 40 includes a first fixture 44 for rotatively mounting thereon first tape roll 45 that has rolled thereon first tape ribbon 52. A second fixture 42 rotatively mounts second tape roll 43 that has rolled thereon second tape ribbon 54. The tape rolls 43 and 45 are laterally offset so as to orient the tape ribbons 52, 54 the desired lateral offset I of the finished tape pair 50, as shown in FIG. 6. The tape ribbons 52, 54 are transported along a tape transport path to a tape pair roll 47 that is rotatively mounted on fixture 46. Adhesive backing 55 on tape ribbon 54 adhesively couples to the facing surface of tape ribbon 52. Remaining exposed adhesive backing 53, 54 adheres the tape pair 50 to a desired portion of the stator coil 20, such as the lead 30 that is schematically shown in FIG. 7, or to underlying tape layers that were already applied to the stator coil.

As shown in FIG. 7, overlapping portions of successive tape pair 50 wrapping loops are adhered to each other, ultimately forming a two-layer (i.e., 52, 54) having the precise offset I for each successive wrapping loop that was established when the tape pair was constructed. Thus, a single wrapping sequence applies two tape layers at a precise, pre-defined offset. As the tape pair 50 is wider than either individual, tape ribbon 52, 54, fewer sequential wrap turns are needed to wrap a given linear length of coil. The coil 20 wrapping method of the present invention, utilizing paired tape 50, applies twice the number of layers, at precise preset offset, with fewer lateral turn wraps in any wrapping sequence than can be done by known single-layer 36 wrapping methods. While the exemplary wrapping sequence shown in FIG. 7 is from right to left, one skilled in the art may choose to wrap from left to right.

The insulating tape wrapping methods of the present invention also facilitate easier fabrication of multi-layer tape insulation, than the known single layer wrapping methods, as is shown in FIGS. 8-8G. The exemplary coil lead 30 has its conductive wire core 32 wrapped sequentially by multiple layers of insulating tape pairs 50 applied with the methods of the present invention and/or single layers 36 applied by known methods.

In FIG. 3A the coil lead 30 is wrapped by a tape pair 50, so that two layers of tape ribbons 52, 54 cover the lead in a single wrapping sequence. The desired lateral offset 1 being preset when forming the tape pair 50 is preserved throughout the wrapping sequence. As previously noted, each ribbon 52, 54 may be constructed of the same or different materials. In the latter combination of different materials, tape layer 52 will be different than layer 54.

FIG. 8B shows an exemplary three layer tape insulation applied over coil lead 30, that is constructed by wrapping a tape pair 50 (resulting in two tape layers 52 and 54), over a single layer wrap 36. If desired the wrapping sequence can be reversed so that the single layer wrap 36 is applied over the tape pair 50 wrap.

FIG. 8C shows an exemplary four layer tape insulation over coil lead 30, that is constructed by wrapping a tape pair 50 (resulting in two tape layers 52 and 54), followed wrapping a second tape pair 50. Other insulating tape layer combinations may be wrapped about a conductive coil by application of desired single layers 36 and tape pair 50 layers in any desired tape material sequence or wrapping direction, to achieve the desired final product taping specification.

Although various embodiments which incorporate the teachings of the present invention have been shown and described in detail herein, those skilled in the art can readily devise many other varied embodiments that still incorporate these teachings.

1. A method for insulating an electrodynamic machine conductive coil, comprising:
providing a tape pair having laterally overlapping coupled first and second tape ribbons; and
wrapping the tape pair about at least a portion of an electrodynamic machine conductive coil.

2. The method of claim 1, wherein the conductive coil is an induction motor stator coil and the portion thereof is selected from the group consisting of a coil straight portion, a coil end portion or a coil lead.

3. The method of claim 1, wherein the tape ribbons include material selected from the group consisting of mica or mica paper that are bonded onto a carrier selected from the group consisting of polymer film or glass material.

4. The method of claim 1 wherein the first and second tape ribbons are constructed of different material.

5. The method of claim 1, wherein the first and second tape ribbons are adhesively coupled.

6. The method of claim 1, further comprising wrapping another tape layer over the wrapped tape pair, and forming a multi-layer tape insulation.

7. The method of claim 1, further comprising wrapping a second tape pair over the first wrapped tape pair, and forming a multi-layer tape insulation.

8. A method for insulating an electrodynamic machine conductive coil, comprising:
forming a tape pair having laterally overlapping coupled first and second tape ribbons; and
wrapping the tape pair about at least a portion of an electrodynamic machine conductive coil.

9. The method of claim 8, wherein the conductive coil is an induction motor stator coil and the portion thereof is selected from the group consisting of a coil straight portion, a coil end portion or a coil lead.

10. The method of claim 8, wherein the tape ribbons include material selected from the group consisting of mica or mica paper that are bonded onto a carrier selected from the group consisting of polymer film or glass material.

11. The method of claim 8 wherein the first and second tape ribbons are constructed of different material.

12. The method of claim 8, wherein the first and second tape ribbons are adhesively coupled.

13. The method of claim 8, further comprising wrapping another tape layer over the wrapped tape pair, and forming a multi-layer tape insulation.

14. The method of claim 8, further comprising wrapping a second tape pair over the first wrapped tape pair, and forming a multi-layer tape insulation.

15. A method for insulating electrodynamic machine conductive coil, comprising:
providing a tape joining apparatus having:
a rotatively mounted first tape roll of adhesive backed first tape ribbon;
a rotatively mounted second tape roll of adhesive backed second tape ribbon;
a rotatively mounted third tape roll downstream the first and second rolls;
transporting the first and second tape ribbons along a tape transport path to the third tape roll;
laterally overlapping respective adjacent edges of the first and second tape ribbons in the tape transport path, so as to form an adhesively coupled tape pair;
taking up the coupled tape pair on the third tape roll; and
wrapping the tape pair about at least a portion of an electrodynamic machine conductive coil.

16. The method of claim 15, wherein the conductive coil is an induction motor stator coil and the portion thereof is selected from the group consisting of a coil straight portion, a coil end portion or a coil lead.

17. The method of claim 15, wherein the tape ribbons include material selected from the group consisting of mica or mica paper that are bonded onto a carrier selected from the group consisting of polymer film or glass material.

18. The method of claim 15, wherein the first and second tape ribbons are constructed of different material.

19. The method of claim 15, further comprising wrapping another tape layer over the wrapped tape pair, and forming a multi-layer tape insulation.

20. The method of claim 15, further comprising wrapping a second tape pair over the first wrapped tape pair, and forming a multi-layer tape insulation.
